(19) United States
(12) Patent Application Publication
(10) Pub. No.: US 2012/0274664 A1
(43) Pub. Date: Nov. 1, 2012

(54) Mobile Device Application for Oilfield Data Visualization

(76) Inventor: Marc Fagnou, Paris (FR)

(21) Appl. No.: 13/410,200

(22) Filed: Mar. 1, 2012

Related U.S. Application Data
(60) Provisional application No. 61/480,414, filed on Apr. 29, 2011.

(51) Int. Cl. G06F 3/041; G09G 5/00

(52) U.S. Cl. 345/660; 345/173

(57) ABSTRACT

A mobile device provides visualization and manipulation of well data generated from one or more well sites. The well data is collected, stored, and aggregated on one or more aggregated data servers. The mobile device includes a touch screen display, a communication interface, and a processor operatively connected to the touch screen display and the communication interface. The processor is configured to receive well data from the one or more aggregated data servers via the communication interface and display a user interface on the touch screen display that graphically displays elements of the well data. The processor is further configured to receive user inputs from the touch screen display and update the displayed well data on the graphical display based the user inputs received on the touch screen display.

### TECHNICAL FIELD

The disclosure relates generally to the field of well data acquisition and interpretation. More specifically, the disclosure relates to an application for a mobile device includes a viewer for visualizing log data during and/or after operations at a well site.

### BACKGROUND

Well data can include well log data which are measurements, for example with respect to depth, of selected physical parameters (e.g., resistivity, density, porosity) of earth formations penetrated by a wellbore. Well data can also include well measurement data which are measurements, for example with respect to depth, of selected physical parameters (e.g., pressure, temperature, direction/inclination) of wellbore environment/conditions. Well log data may be recorded by deploying various types of measurement instruments into a wellbore after the wellbore has been drilled, moving the instruments along the wellbore, and recording the measurements made by the instruments. One type of well log data recording includes lowering the instruments at the end of an armored electrical cable (e.g., a wireline cable), and recording the measurements made with respect to the length of the cable extended into the wellbore. Depth within the wellbore may be inferred from the extended length of the cable. Recordings made in this way can be substantially directly correlated to measurement depth within the wellbore. Well log and/or measurement data may also be obtained using “logging while drilling” (LWD) and/or “measurement while drilling” (MWD) which includes attaching the measurement instruments to the lower portion of a drilling tool assembly used to drill the wellbore and recording the measurements made by the instruments while the assembly is drilling the wellbore. Some of the measurements made can be transmitted to the surface in real time using a pressure modulation telemetry system, which modulates pressure of a drilling fluid (mud) flowing through the interior of the drilling tool assembly. A larger amount of well log/measurement data may be stored in a recording device disposed in the logging/measurement instrument, which can be interrogated when the instrument is retrieved from the wellbore. This information is typically recorded with respect to time. A record of instrument position in the wellbore with respect to time made at the earth's surface can then be correlated to the time/measurement record retrieved from the instrument storage device to generate a “log” of measurements with respect to wellbore depth.

### SUMMARY

Disclosed herein are embodiments of an application for a mobile device including a viewer for visualizing log data during and/or after operations at a well site.

In Example 1, a mobile device provides visualization and manipulation of well data generated from one or more well sites. The well data is collected, stored, and aggregated on one or more aggregated data servers. The mobile device includes a touch screen display, a communication interface, and a processor operatively connected to the touch screen display and the communication interface. The processor is configured to receive well data from the one or more aggregated data servers via the communication interface and display a user interface on the touch screen display that graphically displays elements of the well data. The processor is further configured to receive user inputs from the touch screen display and update the displayed well data on the graphical display based the user inputs received on the touch screen display.

In Example 2, the mobile device of Example 1, wherein the processor is configured to receive a swiping input on the touch screen display and shift the graphically displayed elements of the well data in a direction of the swiping input.

In Example 3, the mobile device of either preceding Example, wherein the processor is configured to provide access to a plurality of log formats on the touch screen display, each log format based on a data subset from the well data, wherein the processor is configured to change a log format displayed on the touch screen display in response to the swiping input.

In Example 4, the mobile device of any preceding Example, wherein the processor is configured to receive a press-and-hold input at a position on the touch screen display, and wherein the processor is further configured to display one or more parameter values on the user interface at the position of the press-and-hold input.

In Example 5, the mobile device of any preceding Example, wherein the processor is configured to receive a pinch input or splay input on the touch screen display, and wherein the processor is further configured to zoom out on the graphically displayed well data elements in response to a pinch input and to zoom in on the graphically displayed well data elements in response to a splay input.

In Example 6, the mobile device of any preceding Example, wherein the processor is configured to provide access to a plurality of selectable log format display options on the user interface, each log format display option associated with a displayable log format based on a data subset from the well data, wherein the log format display options are provided in order of relevance of the associated log format to the well data.

In Example 7, the mobile device of any preceding Example, wherein the processor is configured to generate a log view when one of the log format display options is selected on the touch screen display, and wherein the processor is further configured to display a selectable log view preview of each of the log views and display the log view associated with the log view preview selected on the touch screen display.

In Example 8, the mobile device of any preceding Example, wherein the processor is configured to provide access to an email delivery option on the user interface to facilitate email delivery of the graphically displayed well data and to facilitate access to the well data.

In Example 9, the mobile device of any preceding Example, wherein the processor is configured to provide a data range selection screen on the user interface that facilitates selection of a range of a well data parameter for graphical display on the touch screen display.

In Example 10, the mobile device of any preceding Example, wherein the processor is configured to display a preview thumbnail on the data range selection screen, and wherein the preview thumbnail provides a preview of the graphically displayed elements of the well data in the selected range of the well data parameter.

In Example 11, the mobile device of any preceding Example, wherein the well data parameter is well depth.

In Example 12, the mobile device of any preceding Example, wherein the processor is configured to facilitate display of a plurality of discontinuous well depth ranges simultaneously on the touch screen display.

In Example 13, the mobile device of any preceding Example, wherein the processor is configured to communicate with one or more other mobile devices via the communication interface.

In Example 14, the mobile device of any preceding Example, wherein the processor is configured to collaborate with the one or more other mobile devices to graphically display the elements of the well data across a plurality of mobile devices.

In Example 15, the mobile device of any preceding Example, wherein the processor is configured to communicate with the one or more other mobile devices to display a different parameter range of the well data on each of the mobile devices.

In Example 16, the mobile device of any preceding Example, wherein the processor is configured update the well data parameter ranges displayed on the collaborating one or more other mobile devices in response to user inputs on the touch screen display.

In Example 17, the mobile device of any preceding Example, wherein the processor is configured to generate a log interpretation chart based on the well data in response to selection of a log interpretation chart generation option on the user interface.

In Example 18, the mobile device of any preceding Example, wherein the processor is configured to graphically display the log interpretation chart on the touch screen display in conjunction with the well data elements, and wherein the processor is further configured to adjust the information displayed on the log interpretation chart in response to user inputs on the user interface.

While multiple embodiments are disclosed, still other embodiments will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIGS. 1A-1D illustrate oilfields having subterranean formations containing reservoirs therein with various operations being performed on the oilfields.

FIGS. 2A-2D are graphic representations of examples of data collected by the tools illustrated in FIGS. 1A-1D, respectively.

FIG. 3 shows an oilfield having data acquisition tools positioned at various locations along the oilfield for collecting data of a subterranean formation.

FIG. 4 shows a well site depicting a drilling operation of an oilfield.

FIG. 5 is a schematic view of a system for performing a drilling operation of an oilfield.

FIG. 6 is a block diagram illustrating the general layout for a multiple rig collaboration.

FIG. 7 is a screen shot of a mobile device application including an interactive user interface for visualization of well data.

FIG. 8 is a screen shot of the mobile device application including an interactive user interface for setting data parameter ranges for display on the mobile device.

FIG. 9 is a screen shot of the mobile device application including an interactive user interface for selecting a well data log format for display on the mobile device.

FIG. 10 is a screen shot of the mobile device application including an interactive user interface showing indicators that specify parameter values at a selected depth.

FIG. 11 is a screen shot of the mobile device application including an interactive user interface for graphically displaying well data at a plurality of discontinuous depths simultaneously.

FIG. 12 is a screen shot of the mobile device application including an interactive user interface for providing a plurality of selectable well data log formats.

FIG. 13 is a screen shot of the mobile device application including an interactive user interface for displaying a log interpretation chart in conjunction with well data.

FIG. 14 is a plan view of a plurality of mobile devices using the mobile device application and collaborating to display multiple logs of well data at a plurality of depths.

While the disclosure is amenable to various modifications and alternative forms, specific embodiments have been shown by way of example in the drawings and are described in detail below. The disclosure, however, is not limited to the particular embodiments described. On the contrary, the disclosure is intended to cover all modifications, equivalents, and alternatives falling within the scope of the inventive subject matters as defined by the appended claims.

### DETAILED DESCRIPTION

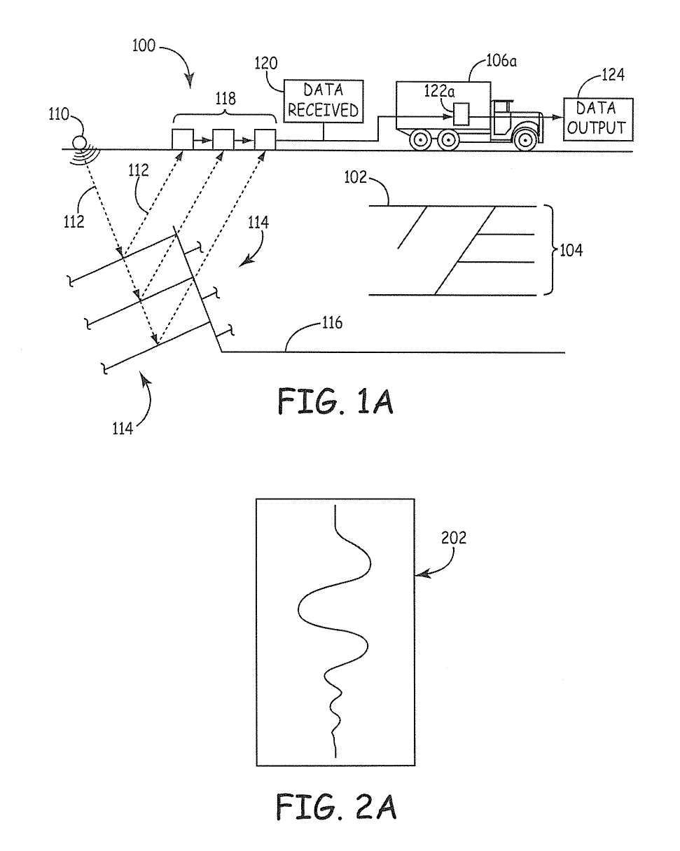

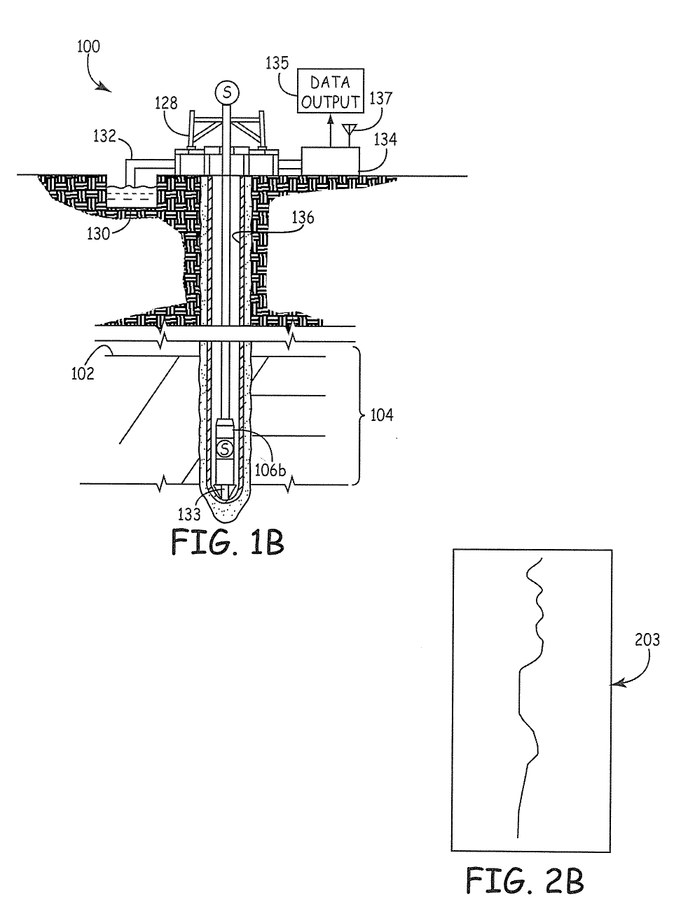

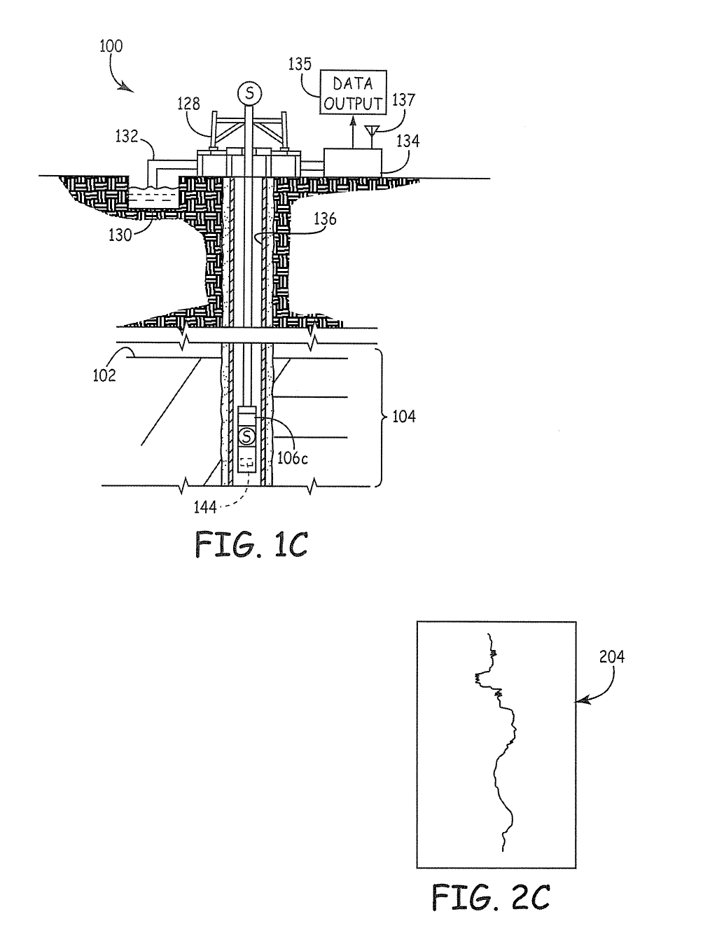

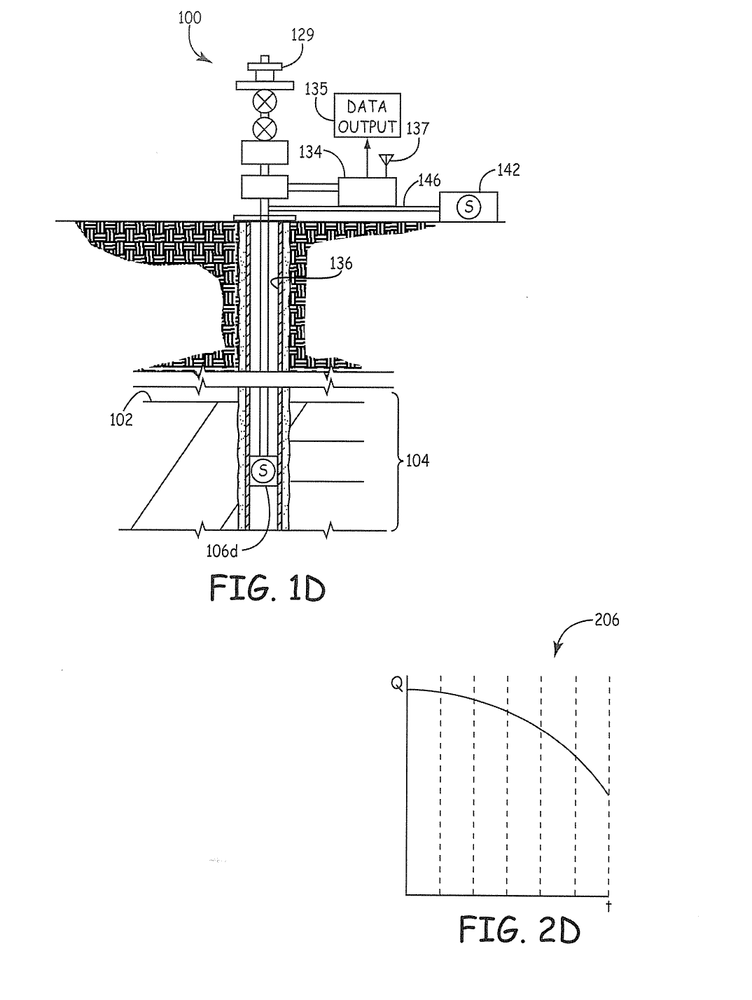

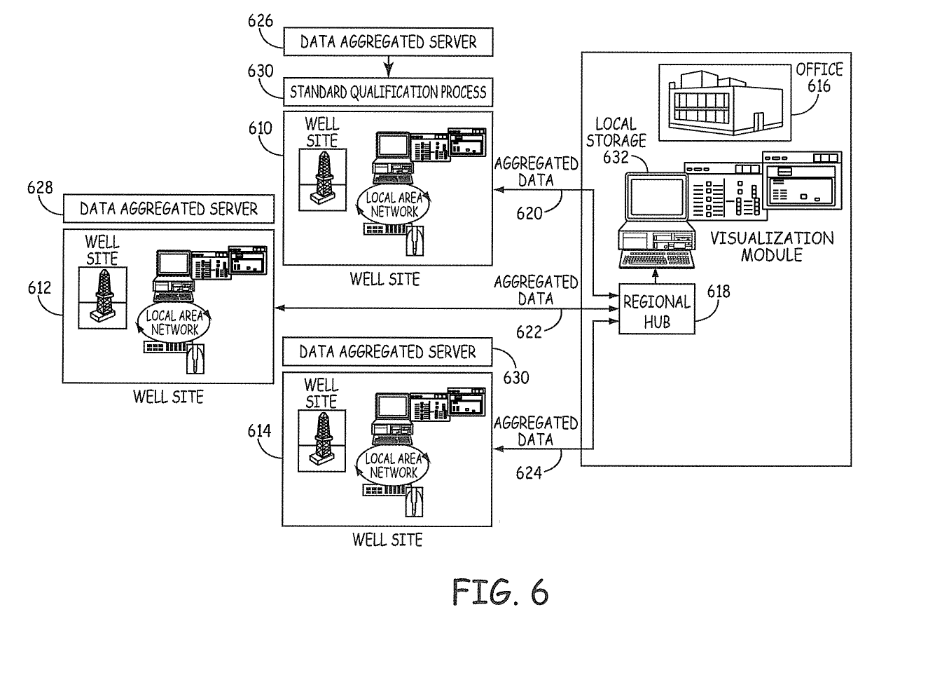

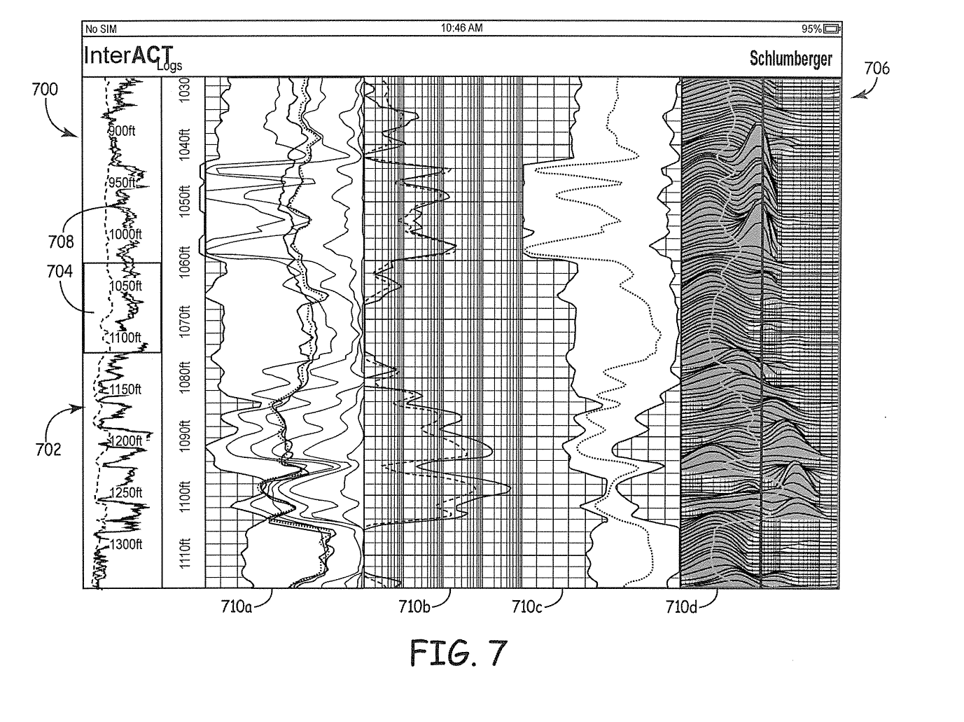

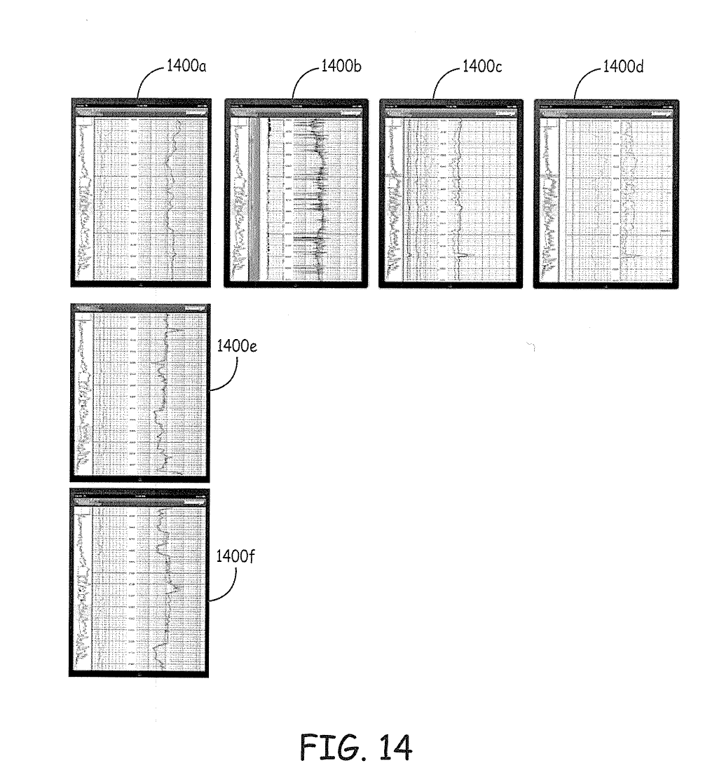

The present disclosure relates to an application for a mobile device including a viewer for visualizing log data during and/or after operations at a well site. The user interface includes one or more visualization modules relevant to the context of the activity being monitored or reviewed. The application facilitates selection of pre-defined or configurable views of the log data on the mobile device. The application also includes a user interface for selecting and modifying parameter ranges and log data visualization formats for display on the viewer. FIGS. 1A-1D, 3, 4, and 5 illustrate exemplary environments and systems for generating data to be displayed and monitored using the mobile device application as described herein. FIGS. 2A-2D illustrate example data generated by the systems of FIGS. 1A-1D. FIG. 6 illustrates an exemplary collaborative infrastructure system for multiple rigs to combine data from multiple sources. FIGS. 7-13 are screen shots from a display on a mobile device, illustrating features of the mobile device application according to the present disclosure. FIG. 14 shows a plurality of mobile devices using the application of the present disclosure and collaborating to display multiple logs of well data at a plurality of depths.

FIGS. 1A-1D depict simplified schematic views of oilfield 100 having subterranean formation 102 containing reservoir 104 therein and depicting various oilfield operations being performed on the oilfield. FIG. 1A depicts a survey operation being performed by a survey tool, such as seismic truck 106a, to measure properties of the subterranean formation 102. The survey operation is a seismic survey operation for producing sound vibrations. In FIG. 1A, one such sound vibration, sound vibration 112 generated by source 110, reflects off horizons 114 in earth formation 116. A set of sound vibration, such as sound vibration 112 is received by sensors, such as geophone-receivers 118, situated on the earth's surface.

In response to the received sound vibration(s) 112 representative of different parameters (such as amplitude and/or frequency) of sound vibration(s) 112, geophones 118 produce electrical output signals containing data concerning subterranean formation 102. Data received 120 is provided as input data to computer 122a of seismic truck 106a, and responsive to the input data, computer 122a generates seismic data output 124. This seismic data output may be stored, transmitted or further processed as desired, for example by data reduction.

FIG. 1B depicts a drilling operation being performed by drilling tool 106b suspended by rig 128 and advanced into subterranean formation 102 to form well bore 136. Mud pit 130 is used to draw drilling mud into the drilling tool 106b via flow line 132 for circulating drilling mud through drilling tool 106b, up well bore 136 and back to the surface. The drilling mud is usually filtered and returned to mud pit 130. A circulating system may be used for storing, controlling, or filtering the flowing drilling mud. The drilling tool 106b is advanced into the subterranean formation 102 to reach reservoir 104. Each well may target one or more reservoirs. Drilling tool 106b may be adapted for measuring downhole properties using logging while drilling (LWD) or measurement while drilling (MWD) tools. The LWD/MWD tool may also be adapted for taking core sample 133 as shown, or removed so that a core sample may be taken using another tool.

Surface unit 134 is used to communicate with the drilling tool 106b and/or offsite operations. Surface unit 134 is capable of communicating with the drilling tool 106b to send commands to the drilling tool 106b, and to receive data therefrom. Surface unit 134 may be provided with computer facilities for receiving, storing, processing, and/or analyzing data from the oilfield. Surface unit 134 collects data generated during the drilling operation and produces data output 135 which may be stored or transmitted. Computer facilities, such as those of the surface unit, may be positioned at various locations about the oilfield and/or at remote locations.

Sensors S, such as gauges, may be positioned about the oilfield 100 to collect data relating to various oilfield operations as described previously. As shown, sensor S may be positioned in one or more locations in the drilling tool 106b and/or at rig 128 to measure drilling parameters, such as weight on bit, torque on bit, pressures, temperatures, flow rates, compositions, rotary speed, and/or other parameters of the oilfield operation (e.g., magnetic resonance). Sensors S may also be positioned in one or more locations in the circulating system.

The data gathered by sensors S may be collected by surface unit 134 and/or other data collection sources for analysis or other processing. The data collected by sensors S may be used alone or in combination with other data. The data may be collected in one or more databases and/or transmitted on or offsite. All or select portions of the data may be selectively used for analyzing and/or predicting oilfield operations of the current and/or other well bores. The data may be historical data, real time data, or combinations thereof. The real time data may be used in real time, or stored for later use. The data may also be combined with historical data or other inputs for further analysis. The data may be stored in separate databases, or combined into a single database.

The collected data may be used to perform analysis, such as modeling operations. For example, seismic data (described above with regard to FIG. 1A) may be used to perform geological, geophysical, and/or reservoir engineering. The reservoir, well bore, surface, and/or process data may be used to perform reservoir, well bore, geological, geophysical, or other simulations. The data outputs from the oilfield operation may be generated directly from the sensors, or after some preprocessing or modeling. These data outputs may act as inputs for further analysis.

The data may also be stored at surface unit 134. One or more surface units may be located at oilfield 100, or connected remotely thereto. Surface unit 134 may be a single unit, or a complex network of units used to perform the necessary data management functions throughout the oilfield. Surface unit 134 may be a manual or automatic system. Surface unit 134 may be operated and/or adjusted by a user.

Surface unit 134 may be provided with transceiver 137 to allow communications between surface unit 134 and various portions of oilfield 100 or other locations. Surface unit 134 may also be provided with or functionally connected to one or more controllers for actuating mechanisms at oilfield 100. Surface unit 134 may then send command signals to oilfield 100 in response to data received. Surface unit 134 may receive commands via the transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the oilfield operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1C depicts a wireline operation being performed by wireline tool 106c suspended by rig 128 and into well bore 136. Wireline tool 106c may be adapted for deployment into a well bore for generating well logs, performing downhole tests and/or collecting samples. Compared to the drilling tool operation depicted in FIG. 1B, wireline tool 106c may be used to provide another method and apparatus for collecting information about the subterranean formations. Wireline tool 106c may, for example, have an explosive, radioactive, electrical, or acoustic energy source 144 that sends and/or receives signals to surrounding subterranean formation 102 and fluids therein.

Wireline tool 106c may be operatively connected to, for example, geophones 118 and computer 122a of seismic truck 106a of FIG. 1A (e.g., to generate seismic data). Wireline tool 106c may also provide data to surface unit 134. Surface unit 134 collects data generated during the wireline operation and produces data output 135 that may be stored or transmitted. Wireline tool 106c may be positioned at various depths in the well bore 136 to provide a survey or other information relating to the subterranean formation 102.

Sensors S, such as gauges, may be positioned about oilfield 100 to collect data relating to various oilfield operations as described previously. As shown, the sensor S is positioned in wireline tool 106c to measure downhole parameters which relate to, for example porosity, permeability, fluid composition and/or other parameters of the oilfield operation.

FIG. 1D depicts a production operation being performed by production tool 106d deployed from a production unit or Christmas tree 129 and into completed well bore 136 for drawing fluid from the downhole reservoirs 104 into surface facilities 142. Fluid flows from reservoirs 104 through perforations in the casing (not shown) and into production tool 106d in well bore 136 and to surface facilities 142 via a gathering network 146.

Sensors S, such as gauges, may be positioned about oilfield 100 to collect data relating to various oilfield operations as described previously. As shown, the sensor S may be positioned in production tool 106d or associated equipment, such as Christmas tree 129, gathering network 146, surface facility 142, and/or other production facility, to measure fluid parameters, such as fluid composition, flow rates, pressures, temperatures, and/or other parameters of the production operation.

While only simplified well site configurations are shown, it will be appreciated that the oilfield may cover a portion of land, sea, and/or water locations that hosts one or more well sites. Production may also include injection wells (not shown) for added recovery. One or more gathering facilities may be operatively connected to one or more of the well sites for selectively collecting downhole fluids from the well site(s).

While FIGS. 1B-1D only depict certain data acquisition tools, various measurement tools capable of sensing parameters, such as seismic two-way travel time, density, resistivity, production rate, etc., of the subterranean formation and/or its geological features may also be used. Various sensors S may be located at various positions along the well bore and/or the monitoring tools to collect and/or monitor the desired data. Other sources of data may also be provided from offsite locations.

The oilfield configuration of FIGS. 1A-1D is intended to provide a brief description of an example of an oilfield usable with embodiments described herein. Part, or all, of oilfield 100 may be on land, water, and/or sea. Also, while a single oilfield measured at a single location is depicted, embodiments described herein may be utilized with any combination of one or more oilfields, one or more processing facilities and one or more well sites.

FIGS. 2A-2D are graphical depictions of examples of data collected by the tools of FIGS. 1A-1D, respectively. FIG. 2A depicts seismic trace 202 of the subterranean formation 102 of FIG. 1A taken by seismic truck 106a. Seismic trace 202 may be used to provide data, such as a two-way response over a period of time. FIG. 2B depicts material data trace 203 for core sample 133 which, as described above, is taken by drilling tool 106b. Core sample 133 may be used to provide data for the material data trace 203, such as data related to the density, porosity, permeability, or other physical property of the core sample 133 over the length of the core sample 133. Tests for density and viscosity may be performed on the fluids in the core at varying pressures and temperatures. FIG. 2C depicts well log 204 of the subterranean formation 102 of FIG. 1C taken by wireline tool 106c. The wireline log 204 typically provides a resistivity or other measurement of the formation at various depths. FIG. 2D depicts a production decline curve or graph 206 of fluid flowing through the well bore 136 of FIG. 1D measured at surface facilities 142. The production decline curve 206 typically provides the production rate Q as a function of time t.

The respective graphs of FIGS. 2A-2C depict examples of static measurements that may describe or provide information about the physical characteristics of the formation and reservoirs contained therein. These measurements may be analyzed to better define the properties of the formation(s) and/or determine the accuracy of the measurements and/or for checking for errors. The plots of each of the respective measurements may be aligned and scaled for comparison and verification of the properties.

FIG. 2D depicts an example of a dynamic measurement of the properties of fluid flowing through the well bore. As the fluid flows through the well bore, measurements can be taken of fluid properties, such as flow rates, pressures, composition, etc. As described below, the static and dynamic measurements may be analyzed and used to generate models of the subterranean formation to determine characteristics thereof. Similar measurements may also be used to measure changes in various aspects of the formation over time.

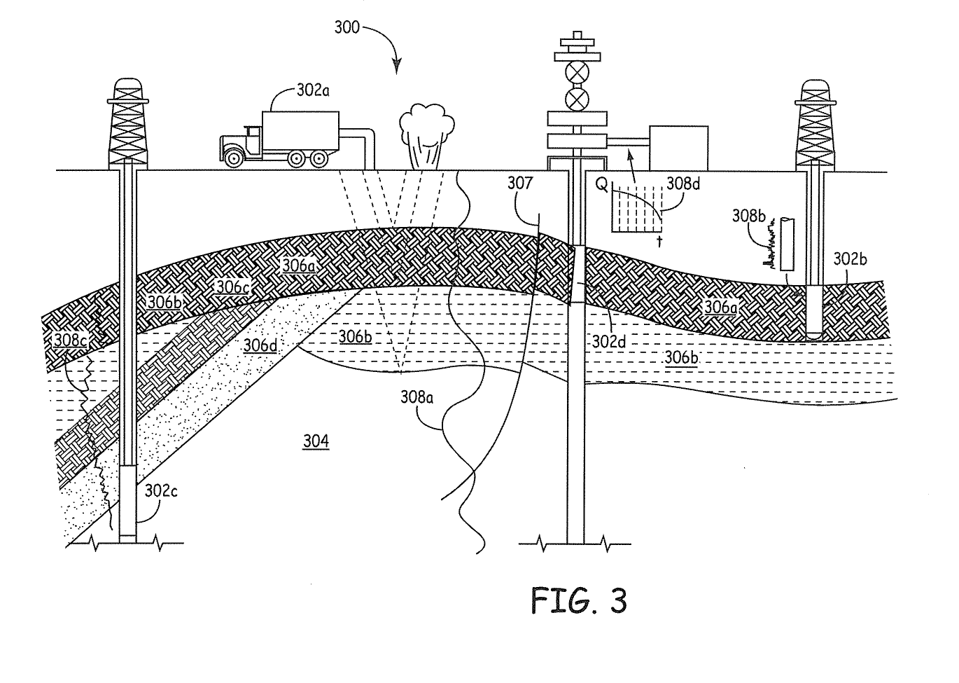

FIG. 3 is a schematic view, partially in cross section of oilfield 300 having data acquisition tools 302a, 302b, 302c and 302d positioned at various locations along the oilfield for collecting data of the subterranean formation 304. Data acquisition tools 302a-302d may be the same as data acquisition tools 106a-106d of FIGS. 1A-1D, respectively, or other data acquisition tools not depicted. As shown, data acquisition tools 302a-302d generate data plots or measurements 308a-308d, respectively. These data plots are depicted along the oilfield to demonstrate the data generated by the various operations.

Data plots 308a-308c are examples of static data plots that may be generated by data acquisition tools 302a-302c, respectively. Static data plot 308a is a seismic two-way response time and may be the same as seismic trace 202 of FIG. 2A. Static plot 308b is core sample data measured from a core sample of formation 304, similar to core sample data 133 of FIG. 2B. Static data plot 308c is a logging trace, similar to well log 204 of FIG. 2C. Production decline curve or graph 308d that may be generated by data acquisition tool 302d is a dynamic data plot of the fluid flow rate over time, similar to graph 206 of FIG. 2D. Other data may also be collected, such as historical data, user inputs, economic information, and/or other measurement data and other parameters of interest.

Subterranean structure 304 has a plurality of geological formations 306a-306d. As shown, this structure 304 has several formations or layers, including shale layer 306a, carbonate layer 306b, shale layer 306c and sand layer 306d. Fault 307 extends through shale layer 306a and carbonate layer 306b. The static data acquisition tools, e.g., tools 302a-302c, may be adapted to take measurements and detect characteristics of the formations 306a-306d.

While a specific subterranean formation with specific geological structures is depicted, it will be appreciated that the oilfield may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in the oilfield, it will be appreciated that one or more types of measurement may be taken at one or more locations across one or more oilfields or other locations for comparison and/or analysis.

The data collected from various sources, such as the data acquisition tools of FIG. 3 (and also the data acquisition tools depicted in FIGS. 1A-D), may then be processed and/or evaluated. For example, seismic data displayed in static data plot 308a from data acquisition tool 302a may be used by a geophysicist to determine characteristics of the subterranean formations and features. Core data shown in static plot 308b and/or log data from well log 308c are typically used by a geologist to determine various characteristics of the subterranean formations. Production data from graph 308d may be used by the reservoir engineer to determine reservoir fluid flow characteristics. The data analyzed by the geologist, geophysicist and the reservoir engineer may be analyzed using modeling techniques.

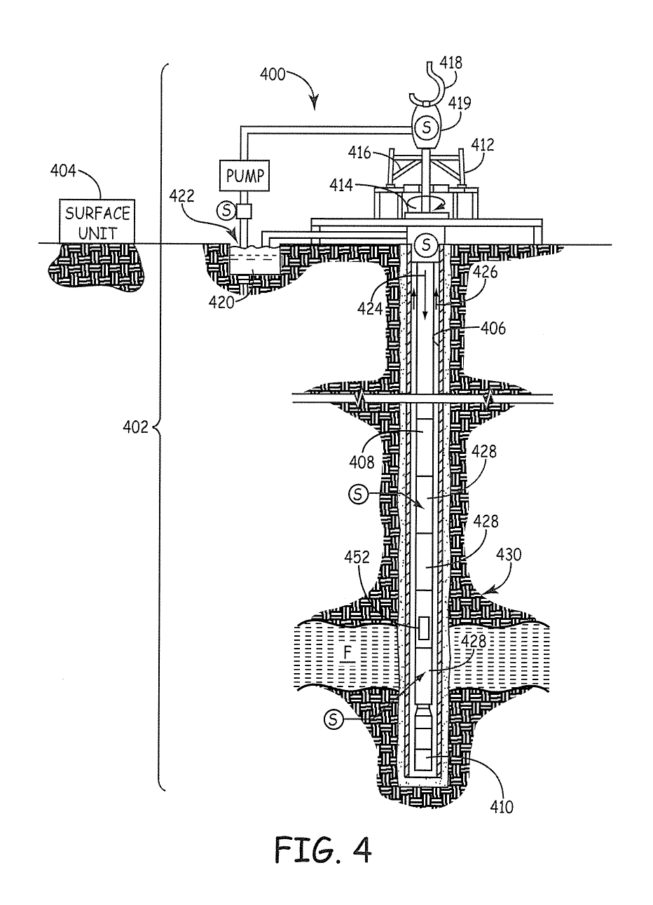

FIG. 4 is a schematic view of well site 400, depicting a drilling operation, such as the drilling operation of FIG. 1B, of an oilfield in detail. Well site 400 may include drilling system 402 and surface unit 404. In the illustrated embodiment, borehole 406 is formed by rotary drilling in a manner that is well known. Those of ordinary skill in the art given the benefit of this disclosure will appreciate, however, that this disclosure also finds application in drilling applications other than conventional rotary drilling (e.g., mud-motor based directional drilling), and is not limited to land-based rigs.

Drilling system 402 may include drill string 408 suspended within borehole 406 with drill bit 410 at its lower end. Drilling system 402 may also include the land-based platform and derrick assembly 412 positioned over borehole 406 penetrating subsurface formation F. In this illustrative example, assembly 412 includes rotary table 414, kelly 416, hook 418, and rotary swivel 419. The drill string 408 is rotated by rotary table 414, energized by known means not shown, which engages kelly 416 at the upper end of the drill string 408. Drill string 408 is suspended from hook 418, attached to a traveling block (also not shown), through kelly 416 and rotary swivel 419 which permits rotation of the drill string 408 relative to the hook 418.

Drilling system 402 may further include drilling fluid or mud 420 stored in pit 422 formed at the well site 400. Pump 424 delivers drilling fluid 420 to the interior of drill string 408 via a port in swivel 419, inducing the drilling fluid 420 to flow downwardly through drill string 408 as indicated by directional arrow 424. The drilling fluid 420 exits drill string 408 via ports in drill bit 410, and then circulates upwardly through the region between the outside of drill string 408 and the wall of borehole 406, called annulus 426. In this manner, drilling fluid 420 lubricates drill bit 410 and carries formation cuttings up to the surface as it is returned to pit 422 for recirculation.

Drill string 408 may include bottom hole assembly (BHA) 430, generally referenced, near drill bit 410 (in other words, within several drill collar lengths from the drill bit). Bottom hole assembly 430 can include capabilities for measuring, processing, and storing information, as well as communicating with surface unit 404. Bottom hole assembly 430 can further include drill collars 428 for performing various other measurement functions.

Sensors S may be located about well site 400 to collect data, in some cases in real time, concerning the operation of well site 400, as well as conditions at well site 400. Sensors S of FIG. 4 may be the same as sensors S of FIGS. 1A-D. Sensors S of FIG. 4 may also have features or capabilities, such as cameras (not shown), to provide pictures of the operation. Sensors S, which may include surface sensors or gauges, may be deployed about the surface systems to provide information about surface unit 404, such as standpipe pressure, hookload, depth, surface torque, rotary rpm, among others. In addition, sensors S, which include downhole sensors or gauges, are disposed about the drilling tool and/or well bore to provide information about downhole conditions, such as well bore pressure, weight on bit, torque on bit, direction, inclination, collar rpm, tool temperature, annular temperature and toolface, among others. The information collected by the sensors and cameras is conveyed to the various parts of the drilling system and/or the surface control unit.

Drilling system 402 can be operatively connected to surface unit 404 for communication therewith. Bottom hole assembly 430 may be provided with communication subassembly 452 that communicates with surface unit 404. Communication subassembly 452 can be adapted to send signals to and receive signals from the surface using mud pulse telemetry. Communication subassembly 452 may include, for example, a transmitter that generates a signal, such as an acoustic or electromagnetic signal, which is representative of the measured drilling parameters. Communication between the downhole and surface systems is depicted as being mud pulse telemetry, such as the one described in U.S. Pat. No. 5,517,464, assigned to the assignee of the present application. It will be appreciated that a variety of telemetry systems may be employed, such as wired drill pipe, electromagnetic, or other known telemetry systems.

The well bore may be drilled according to a drilling plan that is established prior to drilling. The drilling plan typically sets forth equipment, pressures, trajectories and/or other parameters that define the drilling process for the well site. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

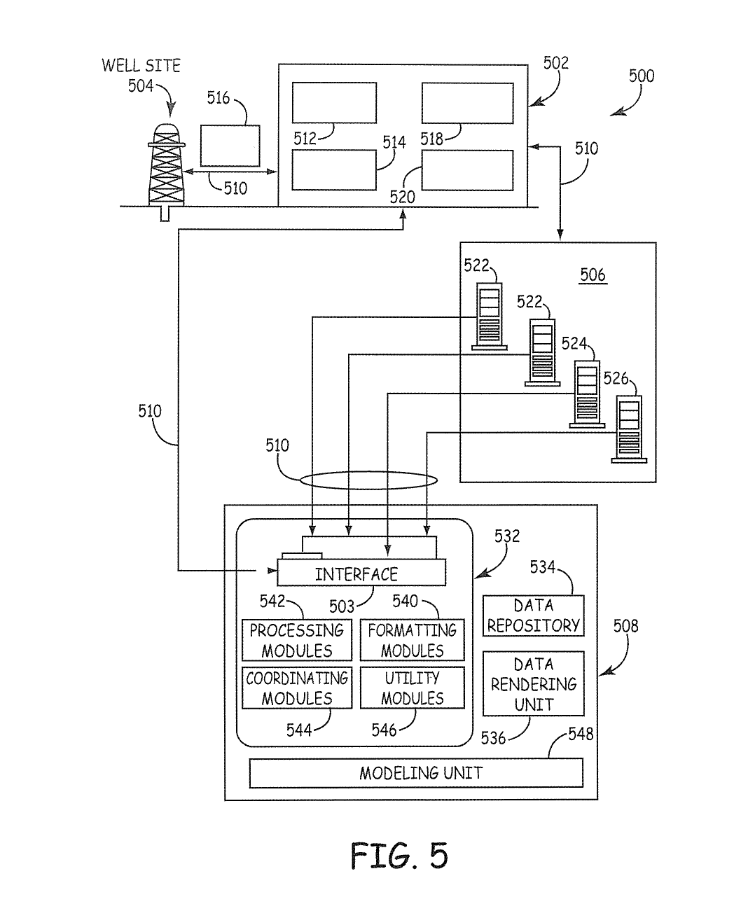

FIG. 5 is a schematic view of control system 500 for controlling a drilling operation of an oilfield. As shown, control system 500 may include surface unit 502 operatively connected to well site 504, servers 506 operatively linked to surface unit 502, and modeling tool 508 operatively linked to servers 506. As shown, communication links 510 may be provided between well site 504, surface unit 502, servers 506, and modeling tool 508. A variety of links may be provided to facilitate the flow of data through the system. The communication links may provide for continuous, intermittent, one-way, two-way, and/or selective communication throughout system 500. The communication links may be of any type, such as wired, wireless, etc.

Well site 504 and surface unit 502 may be the same as the well site and surface unit of FIG. 4. Surface unit 502 may be provided with an acquisition component 512, controller 514, display unit 516, processor 518 and transceiver 520. Acquisition component 512 collects and/or stores data of the oilfield. This data may be data measured by the sensors S of the well site as described with respect to FIG. 4. This data may also be data received from other sources.

Controller 514 is enabled to enact commands at the oilfield. Controller 514 may be provided with actuation means that can perform drilling operations, such as steering, advancing, or otherwise taking action at the well site. Drilling operations may also include, for example, acquiring and analyzing oilfield data, modeling oilfield data, managing existing oilfields, identifying production parameters, maintenance activities, or any other actions. Commands may be generated based on logic of processor 518, or by commands received from other sources. Processor 518 may be provided with features for manipulating and analyzing the data. Processor 518 may be provided with additional functionality to perform oilfield operations.

Display unit 516 may be provided at well site 504 and/or remote locations for viewing oilfield data. For example, according to some embodiments, the display unit 516 may be provided on a wireless mobile device, such as a tablet computer or cellular phone. The oilfield data displayed may be raw data, processed data, and/or data outputs generated from various data. As will be described in more detail herein, the display may be quickly adapted to provide flexible views of the data, so that the screens depicted may be customized as desired.

Transceiver 520 may provide a means for providing data access to and/or from other sources. Transceiver 520 may also provide a means for communicating with other components, such as servers 506, well site 504, surface unit 502, and/or modeling tool 508. Servers 506 may be used to transfer data from one or more well sites to modeling tool 508. As shown, servers 506 include onsite servers 522, remote server 524, and third party server 526. Onsite servers 522 may be positioned at well site 504 and/or other locations for distributing data from surface unit 502. Remote server 524 is positioned at a location away from well site 504 and provides data from remote sources. Third party server 526 may be onsite or remote, but is operated by a third party, such as a client.

Servers 506 may be capable of transferring drilling data, such as logs/measurements, drilling events, trajectory, and/or other oilfield data, such as seismic data, historical data, economics data, or other data that may be of use during analysis. The type of server is not intended to limit the present disclosure. System 500 may be adapted to function with any type of server that may be employed.

Servers 506 may communicate with modeling tool 508 as indicated by communication links 510 therebetween. As indicated by the multiple arrows, servers 506 may have separate communication links with modeling tool 508. One or more of the servers of servers 506 may be combined or linked to provide a combined communication link.

Servers 506 may be capable of collecting a wide variety of data. The data may be collected from a variety of channels that provide a certain type of data, such as well logs. The data from servers 506 can be passed to modeling tool 508 for processing. Servers 506 may be used to store and/or transfer data.

Modeling tool 508 can be operatively linked to surface unit 502 for receiving data therefrom. In some cases, modeling tool 508 and/or server(s) 506 may be positioned at well site 504. Modeling tool 508 and/or server(s) 506 may also be positioned at various locations. Modeling tool 508 may be operatively linked to surface unit 502 via server(s) 506. Modeling tool 508 may also be included in or located near surface unit 502.

Modeling tool 508 may include interface 503, processing unit 532, modeling unit 548, data repository 534 and data rendering unit 536. Interface 503 can communicate with other components, such as servers 506. Interface 503 may also permit communication with other oilfield or non-oilfield sources. Interface 503 can receive the data and map the data for processing. Data from servers 506 typically streams along predefined channels which may be selected by interface 503.

As depicted in FIG. 5, interface 503 can select the data channel of server(s) 506 and receive the data. Interface 503 may also map the data channels to data from well site 504. The data may then be passed to the processing unit 532 of modeling tool 508. The data may be immediately incorporated into modeling tool 508 for real-time sessions or modeling. Interface 503 can also create data requests (for example surveys, logs, and risks), display user interface, and handle connection state events. Interface 503 may also instantiate the data into a data object for processing.

Processing unit 532 may include formatting modules 540, processing modules 542, coordinating modules 544, and utility modules 546. These modules are designed to manipulate the oilfield data for real-time or substantially real-time analysis.

Formatting modules 540 can be used to conform data to a desired format for processing. Incoming data may need to be formatted, translated, converted or otherwise manipulated for use. Formatting modules 540 may be configured to enable the data from a variety of sources to be formatted and used so that it processes and displays in real time.

Formatting modules 540 can include components for formatting the data, such as a unit converter and mapping components. The unit converter may convert individual data points received from interface 530 into the format expected for processing. The format may be defined for specific units, provide a conversion factor for converting to the desired units, or allow the units and/or conversion factor to be defined. To facilitate processing, the conversions may be suppressed for desired units.

The mapping component(s) can map data according to a given type or classification, such as a certain unit, log mnemonics, precision, max/min of color table settings, etc. The type for a given set of data may be assigned, particularly when the type is unknown. The assigned type and corresponding map for the data may be stored in a file (e.g. XML) and recalled for future unknown data types.

Coordinating modules 544 may orchestrate the data flow throughout modeling tool 508. The data is manipulated so that it flows according to a choreographed plan. The data may be queued and synchronized so that it is processed according to a timer and/or a given queue size. The coordinating modules 544 may include queuing components, synchronization components, management components, mediator components, settings components and/or real-time handling components.

The queuing components can group the data in a queue for processing through the system. The system of queues provides a certain amount of data at a given time so that it may be processed in real time.

The synchronization components may link certain data together so that collections of different kinds of data may be stored and visualized in modeling tool 508 concurrently. In this manner, certain disparate or similar pieces of data may be choreographed so that they link with other data as the data it flows through the system. The synchronization component may provide the ability to selectively synchronize certain data for processing. For example, log data may be synchronized with trajectory data. Where log samples have a depth that extends beyond the well bore, the samples may be displayed on the canvas using a tangential projection so that, when the actual trajectory data is available, the log samples will be repositioned along the well bore. Alternatively, incoming log samples that are not on the trajectory may be cached so that, when the trajectory data is available, the data samples may be displayed. In cases where the log sample cache fills up before the trajectory data is received, the samples may be committed and displayed.

The settings component can define the settings for the interface. The settings component may be set to a desired format and adjusted as necessary. The format may be saved, for example, in an extensible markup language (XML) file for future use.

The real-time handling component can instantiate and display the interface and handle its events. The real-time handling component may also create the appropriate requests for channel or channel types, and handle the saving and restoring of the interface state when a set of data or its outputs is saved or loaded.

The management component may implement the required interfaces to allow the module to be initialized by and integrated for processing. The mediator component can receives the data from the interface. The mediator may also cache the data and combine the data with other data as necessary. For example, incoming data relating to trajectories, risks, and logs may be added to wellbore models stored in modeling tool 508. The mediator may also merge data, such as survey and log data.

Utility modules 546 can provide support functions to the drilling control system. Utility modules 546 may include logging component and user interface (UI) manager component. The logging component can provide a common call for all logging data. This component allows the logging destination to be set by the application. The logging component may also be provided with other features, such as a debugger, a messenger, and a warning system, among others. The debugger can send a debug message to those using the system. The messenger can send information to subsystems, users, and others. The information may or may not interrupt the operation and may be distributed to various locations and/or users throughout the system. The warning system may be used to send error messages and warnings to various locations and/or users throughout the system. In some cases, the warning messages may interrupt the process and display alerts.

The user interface manager component may create user interface elements for displays. The user interface manager component can define user input screens, such as menu items, context menus, toolbars, and settings windows. The user interface manager component may also be used to handle events relating to these user input screens.

Processing modules 542 may be used to analyze the data and generate outputs. Processing module 542 can include trajectory management component.

The trajectory management component can handle the case when the incoming trajectory information indicates a special situation or requires special handling. The trajectory management component could therefore handle situations where the data pertains to depths that are not strictly increasing or the data indicates that a sidetrack borehole path is being created. For example, when a sample is received with a measured depth shallower than the hole depth, the trajectory management component determines how to process the data. The trajectory management component may ignore all incoming survey points until the measured depth exceeds the previous measured depth on the well bore path, merge all incoming survey points below a specified depth with the existing samples on the trajectory, ignore points above a given depth, delete the existing trajectory data and replace it with a new survey that starts with the incoming survey station, create a new well and set its trajectory to the incoming data, add incoming data to this new well, and prompt the user for each invalid point. All of these options may be exercised in combinations and can be automated or set manually.

Data repository 534 can store the data for modeling unit 548. The data may be stored in a format available for use in real-time. The data may be passed to data repository 534 from the processing unit 532. The date can be persisted in the file system (e.g., as an XML file) or in a database. The control system may determine which storage is the most appropriate to use for a given piece of data and stores the data there in a manner which enables automatic flow of the data through the rest of the system in a seamless and integrated fashion. The control system may also facilitate manual and automated workflows, such as modeling, geological, and geophysical, based upon the persisted data.

Data rendering unit 536 may provide one or more displays for visualizing the data. Data rendering unit 536 may contain a 3D canvas, a well section canvas or other canvases as desired. Data rendering unit 536 may selectively display any combination of one or more canvases. The canvases may or may not be synchronized with each other during display. Data rendering unit 536 may be provided with mechanisms for actuating various canvases or other functions in the control system.

While specific components are depicted and/or described for use in the modules of modeling tool 508, a variety of components with various functions may be used to provide the formatting, processing, utility, and coordination functions necessary to provide real-time processing in modeling tool 508. The components and/or modules may have combined functionalities.

Modeling unit 548 may perform the key modeling functions for generating complex oilfield outputs. Modeling unit 548 may be a conventional modeling tool capable of performing modeling functions, such as generating, analyzing, and manipulating earth models. The earth models typically contain exploration and production data, such as that shown in FIGS. 2A-2D & 3.

Referring now to FIG. 6, a general layout for multiple rig collaboration infrastructures is shown according to an illustrative embodiment. The replication of collaboration infrastructures at multiple rigs in a given oilfield may allow multiple well sites to be remotely supported from a single operations support center. Project team members at the various well sites 610, 612, and 614 may then work together using the collaboration infrastructures to manage the overall drilling process for an entire oilfield asset, thereby providing huge potential increases in efficiency across the entire asset.

The methods, systems, and apparatuses of collaboration infrastructures according to the illustrative embodiment may be used regardless of whether the wells are being drilled in a high-volume, low-cost land environment or a high-cost, low-volume offshore environment. While drilling projects are typically part of a multi-location “virtual” team, the illustrative collaboration infrastructures can facilitate cooperation between the various personnel involved, including an asset management team in office 616, a company man on a rig at well sites 610, 612, and 614, rig contractors and other vendors on the rig at well sites 610, 612, and 614, and engineers and support personnel located at well sites 610, 612, 614 and/or office 616. In some embodiments, the collaboration infrastructures can communicate between well sites 610, 612, and 614 and office 616 via regional hub 618. The collaboration infrastructures may also use enterprise class components coupled with processes and support institutions commensurate with the challenges and difficulties of a well environment, such as an oil well or gas well.

The collaboration infrastructures at the rig at well sites 610, 612, and 614, may aggregate data from a variety of information sources into aggregated data 620, 622, and 624. These sources can include, but are not limited to, information from a rig contractor, mud logger data, measurements-while-drilling data, logging-while-drilling data, information received from a company man, data from pore pressure monitoring, drilling optimization information, and episodic data, such as wireline data, cementing data, and drill-string testing data.

The collaboration infrastructures may also provide real-time access to aggregated data 620, 622, and 624 by the collaboration team regardless of their location at either well sites 610, 612, and 614 or office 616. Aggregated data 620, 622, and 624 can be accessed in real-time by processes such as web-based viewers, interactive viewers, import to analysis applications, and handheld access.

The collaboration infrastructures can also facilitate communication between collaboration team members at similar or identical sites, such as between rig team members of a single well site, such as one of well sites 610, 612, and 614. The collaboration infrastructures, therefore, can provide a number of applications and/or functions, such as, for example, electronic chat applications, instant message applications, shared data analysis, fax, reporting, email, and voice over internet protocol communication. The collaboration infrastructures can additionally provide other applications such as, but not limited to, wired and/or wireless local area networks, video monitoring, facsimile receipt and transmission, private network access, links to sub networks, hazardous area and other real-time displays, integration of personal digital assistants, remote administration, and remote monitoring and support. Further, as described in more detail below, the collaboration infrastructures may also include a network to quickly and efficiently provide real-time or substantially real-time visualization of the aggregated data 620, 622, 624 for end users, such as using a mobile device application is described more fully herein.

The collaboration infrastructures can also provide various security features to limit access to aggregated data 620, 622, and 624. The various security features in one illustrative embodiment can include, but are not limited to, a firewall, a security patch management, personalized access control, hazardous area certification, bandwidth allocation and Quality of Service (QoS), and the ability to track malicious activity.

At office 616, the collaboration infrastructures of FIG. 6 may provide flexible deployment internal and external to a corporate network (i.e., hosted), ease of integration with existing company infrastructure, access to multiple rigs at well sites 610, 612, and 614 as required, sufficient viewing area and real-time displays, rapid assimilation of aggregated data 620, 622, and 624, and ease of context switching. The collaboration infrastructures of FIG. 6 also may provide real-time access to aggregated data 620, 622, and 624 by the remote team at office 616. Real-time access to aggregated data 620, 622, and 624 can include, but not limited to, web-based viewers, interactive viewers, import to analysis applications, and handheld access. For example, as will be described in more detail below, aggregated data 620, 622, and 624 may be viewed using a viewer on mobile devices such as tablets and cellular phones. In addition, inter-communication between remote team members at office 616 may also be provided, including chat, video communication, instant messaging, shared data analysis, facsimile, reporting, email, and voice-over-internet protocol communication. Other services provided by the collaboration infrastructures may include wired and/or wireless local area networks, video monitoring, Personal Digital Assistants, Flexible Administration (Remote/Local), and Flexible Monitoring and Support (Remote/Local). As for security, the collaboration infrastructures may provide a firewall, security patch management, access control, hazardous area certification, bandwidth allocation and Quality of Service (QoS), and can easily conform to client environment.

With respect to the aggregation of aggregated data 620, 622, and 624 and access to this aggregation at office 616, although there may be many possible infrastructure solutions for data aggregation, one illustrative embodiment can utilize data aggregation servers 626, 628, and 630 on individual rigs at well sites 610, 612, and 614. Locating data aggregation servers 626, 628, and 630 on individual rigs at well sites 610, 612, and 614 may provide benefits that outweigh most logistics issues. For example, data aggregation servers 626, 628, and 630 at the rigs can provide an interface to the various vendor systems on the rigs and also provide local access to aggregated data 620, 622, 624. Locating data aggregation servers 626, 628, and 630 at the rigs may also eliminate potential traffic across a communication link from the rigs to office 616. If the data aggregation servers 626, 628, and 630 were located remotely from the rigs, such as at office 616, team members at well sites 610, 612, 614 would have to access data aggregation servers 626, 628, and 630 through the relatively scarce and expensive bandwidth of the communication link.

Data aggregation servers 626, 628, and 630 can aggregate data together to create aggregated data 620, 622, 624 in a way that aggregated data 620, 622, 624 can be viewed and analyzed using a consistent set of tools. That is, aggregated data 620, 622, 624 is not limited strictly to the native tools and software environments provided by the various vendors.

Data aggregation servers 626, 628, and 630 can also combine aggregated data 620, 622, 624 into a consistent and vendor neutral data delivery format. By using the data aggregation servers 626, 628, and 630 to aggregate/combine the data into a standard repository with a standard set of analysis tools, the value of the data can be immediately enhanced. Time that was previously spent analyzing data in the field so that the data can be prepared and implemented into a usable format may be eliminated. Therefore, all of the data collected on rigs at well sites 610, 612, and 614 can be utilized. With the different illustrative embodiments, data would not be simply eliminated because of the complexity of learning the different tools from each vendor or for each data type.

Locating the data aggregation servers 626, 628, and 630 on a rig at well sites 610, 612, and 614 can further allow for controlled and facilitated access to aggregated data 620, 622, and 624. In one illustrative embodiment, data to form aggregated data 620, 622, and 624 may be collected into the data aggregation servers 626, 628, and 630 at the rigs and transmitted to the remote team at office 616, to be stored at local storage 632. Users at a rig at one of well sites 610, 612, and 614 may access aggregated data 620, 622, 624 in real time locally on data aggregation servers 626, 628, 630 and users onshore may access aggregated data 620, 622, 624 from local storage 632 at office 616, thus minimizing the traffic over the satellite communication link or other rig connectivity. Local storage 632 can be a data storage medium that locally mirrors data that is stored at data aggregation servers 626, 628, 630. This bifurcated storage of aggregated data 620, 622, 624 may help eliminate contention for connectivity and bandwidth between office 616 and well sites 610, 612, and 614.

Combining data from well sites 610, 612, and 614 into aggregated data 620, 622, and 624 can include collecting data from a variety of vendors and systems and using various data sharing standards available for rigs. In one illustrative embodiment, the data collaboration infrastructures of FIG. 6 may acquire data in a standard data format. The standard data format can be, for example, but not limited to, the Wellsite Information Transfer Standard (WITS) format, the WITSML format, or the markup language based evolution of the Wellsite Information Transfer Standard format.

In one illustrative embodiment, data aggregation server 626 may include a standard qualification process 630 for new vendors. Standard qualification process 630 can be a software process that maps previously collected sample Wellsite Information Transfer Standard data with associated data descriptions. Once data is mapped, the mapped data can be stored in a knowledge base so that data from that vendor may be acquired and comprehended anywhere. Mapped data obtained from the standard qualification process 630 can be transferred between well sites 610, 612, 614 and office 616 to extend the comprehension of the acquired data.

The mobile device application of the present disclosure can be used on any mobile device capable of receiving and/or sending data via an integrated wireless communication interface. In some embodiments, the mobile device application is configured for use on a tablet computer or cellular telephone. The mobile device can include a user input device to allow interaction between the user and the mobile device application. In some embodiments, the mobile device can include a touch screen display configured to display the interactive user interface and receive user inputs on the touch screen to interact with the user interface. For example, the touch screen display may be responsive to predefined motions provided by the user on the touch screen display, such as tapping (i.e., briefly placing a finger on the touch screen display) swiping (i.e., moving a finger along the surface of the touch screen display), pressing-and-holding (i.e., placing a finger on the surface of the touch screen display and holding the finger in position), pinching (i.e., placing a plurality of fingers on the touch screen display and moving the fingers into closer proximity to each other), and splaying (i.e., placing a plurality of fingers on the touch screen display and moving the fingers further apart).

When the mobile device application is initiated on the mobile device, the application may be configured to require the user to log in (e.g., with a username and password) to access the data from one or more well sites, such as the data stored on the data aggregation servers 626, 628, and/or 630. The application may then be configured to provide a user interface that allows the user to select from one or more active or monitored jobs at the well site(s). The user interface may provide information about the selectable jobs, such as the types and numbers of the sensors and equipment used to monitor the jobs, and the depth of the well(s) associated with each job. When a job is selected, the user interface can be configured to select a viewer for graphically displaying the data from the selected job. Each viewer is configured to graphically display the well data specific to a job at the well site(s). The user interface can also optionally prompt the user for additional inputs related to the data, such as parameter ranges and values to be displayed on the mobile device.

FIG. 7 is a screen shot of a mobile device application including interactive user interface 700 for visualization of well data, such as oil well data or gas well data. In the embodiment shown, interactive user interface 700 includes depth selection bar 702, displayed depth indicator 704, and data display section 706. Depth selection bar 702 shows a range of well depths (relative to the surface) selectable for the display of well data at the selected depths in data display section 706. In some embodiments, depth selection bar 702 also displays data preview 708 that shows a graphical representation of relevant data at each of the depths in depth selection bar 702. Data preview 708 may be employed to verify that data is available for display at a particular depth or depth range. The range of depths displayed on depth selection bar 702 may be changed by providing a swiping input on the touch screen display. For example, interactive user interface 700 can be configured such that a downward swiping input on depth selection bar 702 (as viewed in FIG. 7) shifts the range of well depths in depth selection bar 702 toward the surface, and an upward swiping input on depth selection bar 702 shifts the range of well depths in depth selection bar 702 away from the surface.

Displayed depth indicator 704 is a gauge in depth selection bar 702 that indicates the depths at which data is displayed in data display section 706. The range of depths in display depth indicator 704 is adjustable to change the depths displayed in data display section 706. For example, the limits of the range in display depth indicator 704 may be modified by pressing-and-holding the top or bottom of display depth indicator 704 and swiping up or down, depending on whether a larger or smaller range of depths is desired. As another example, the limits of the range in display depth indicator 704 may be modified simultaneously by using a pinch or splay user input on display depth indicator 704. As a further example, display depth indicator 704 may be moved relative to depth selection bar 702 by pressing-and-holding display depth indicator 704 and swiping display depth indicator 704 up or down, depending on whether lesser or greater depths are to be viewed. Interactive user interface 700 can also be configured such that a pinch or splay motion on data display section 706 modifies the range of depths displayed in data display section 706, and/or a swiping motion on data display section 706 shifts the depth displayed in data display section 706 to lesser or greater depths.

Data display section 706 is a graphical display of well data at the depths set in display depth indicator 704. The data context of the data display section 706 may be related to the segment(s), workflow, and/or tools specific activities discussed above with regard to the oilfield and drilling operations depicted in FIGS. 1-5. For example, in the embodiment shown, the data is displayed in a CMR log format, which relates to data obtained from a combinable magnetic resonance tool using wireline (e.g., wireline tool 106c in FIG. 1C). The CMR log format displays different types of porosity in the formation being drilled. Other log formats may alternatively or additionally be displayed in data display section 706. For example, an array induction imager tool (AIT) log format may be displayed in data display section 706, which relates to measurements of the resistivity of the formation being drilled. As another example, a sonic log format may be displayed in data display section 706, which relates to the velocity of sound through the formation being drilled. Data display section 706 may be configured such that a plurality of different log formats can be accessed. For example, a swiping motion on data display section 706 may be used to toggle between different active log formats.

Interactive user interface 700 can be configured to allow the user to send the data to another user for contemporaneous or later review, such as to collaborate on a project. For example, in some embodiments, interactive user interface 700 can be configured to allow the user to tap the screen to bring up a menu with an option to send data to another user. In one exemplary implementation, the menu is provided with an option to send data via email to another user. When the other user has installed the mobile device application, the other user can select one or more hyperlinks in the email to access the graphically displayed data and/or access the original source of the data on the server. In some embodiments, a file including the log data can also be attached to the email to the other user.

Interactive user interface 700 can also be configured to allow the user to edit aspects of the graphically displayed well data. For example, interactive user interface 700 can be configured to allow the user to select a curve by tapping the curve on the touch screen. The selection of the curve may initiate a menu that allows the user to modify properties of the curve, such as the scale, color, line weight, line style, and visibility of the curve. Interactive user interface 700 can also be configured to receive user input (e.g., tap) on an area of data display section 706 that does not include displayed data to allow the user to edit the data displayed in the area of the selected portion of data display section 706. For example, data display section 706 includes four tracks 710a, 710b, 710c, 710d of displayed data that can be edited if the user selects a portion of the track. A track is a group of displayed data objects with common gridlines. In track editing mode, the user can, for example, select additional data to display on the selected track, update the scale of the gridlines in the selected track, move the position of the track on data display section 706, and delete data from the selected track. The track editing menu can also include a graphic or text that indicates the track selected for editing (e.g., a position bar that illustrates the position of the track relative to other tracks). Interactive user interface 700 can also be configured to allow the user to select a curve and move the curve between tracks on data display section 706, such as by dragging a curve from one track to another track.

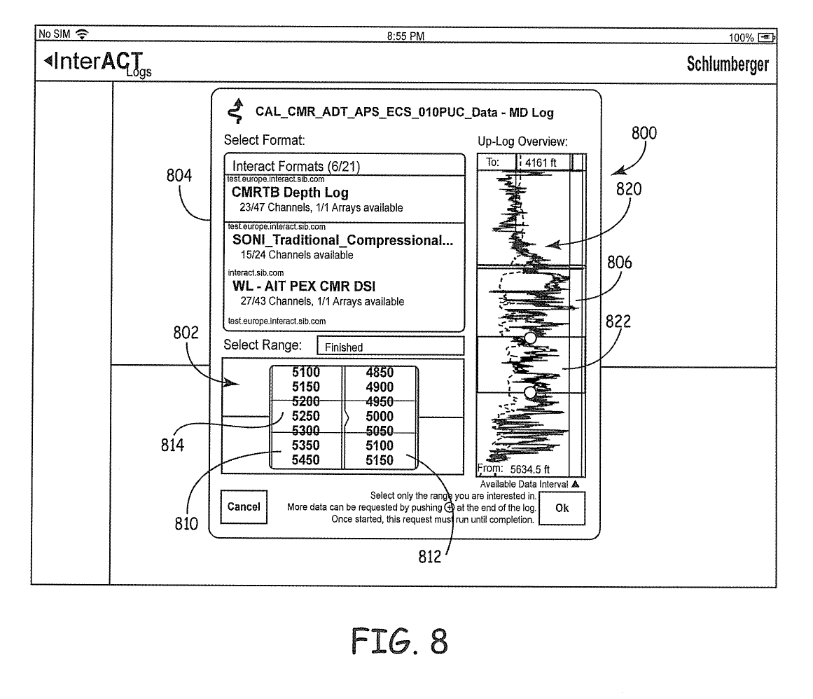

FIG. 8 is a screen shot of the mobile device application showing interactive user interface 800 for setting data parameter ranges for display on the mobile device. Interactive user interface 800 may be accessed by selecting a predetermined option on an interactive menu. Interactive user interface 800 may also be provided when selecting the log format at startup to set the parameter ranges to be displayed in data display section 706.

In the embodiment shown, interactive user interface 800 is configured to allow the user to set the depth range displayed in data display section 706. Interactive user interface 800 includes range setting module 802, log format selection module 804, and preview pane 806. Range setting module 802 is a graphical module that can be manipulated by the user on the touch screen display to set the depth range for display. For example, in the illustrated embodiment, range setting module 802 includes first wheel 810 to set the upper limit of the depth range and second wheel 812 to set the lower limit of the depth range. The selected upper and lower limits on wheels 810, 812 are indicated with a bar 814 extending across wheels 810, 812. To toggle the selected depths, the user can use an up or down swiping input on either of wheels 810, 812 to rotate the swiped wheel 810 or 812 in the direction of the swipe. While wheels 810, 812 are shown on range setting module 802, other suitable interfaces may alternatively be employed to allow the user to set the displayed data range.

Log format selection module 804 allows the user to select from a list of available log formats available for display. Log format selection module 804 may list log formats that are displayable based on the underlying well data. In some embodiments, log format selection module 804 lists the available log formats in order of relevance to the underlying well data. The user can scroll through the list of log formats in log format selection module 804 by providing an up or down swiping input on log format selection module 804.

Preview pane 806 displays a thumbnail image of elements of the well data at depths selected in range setting module 802, and at surrounding depths. Preview pane 806 includes data preview 820, similar to data preview 708 discussed above with regard to FIG. 7. With preview pane 806, the user can determine whether relevant data is available at varying depths without generating the complete log view, thereby reducing processing demands Preview pane 806 also includes depth indicator bar 822, which is configured to show the user the range of depths selected in range setting module 802. When the user updates either or both of the wheels 810, 812, depth indicator bar 822 is correspondingly updated in preview pane 806. When the desired depth range has been set on range setting module 802, the user can press the OK button to update data display section 706 with data at the selected depths.

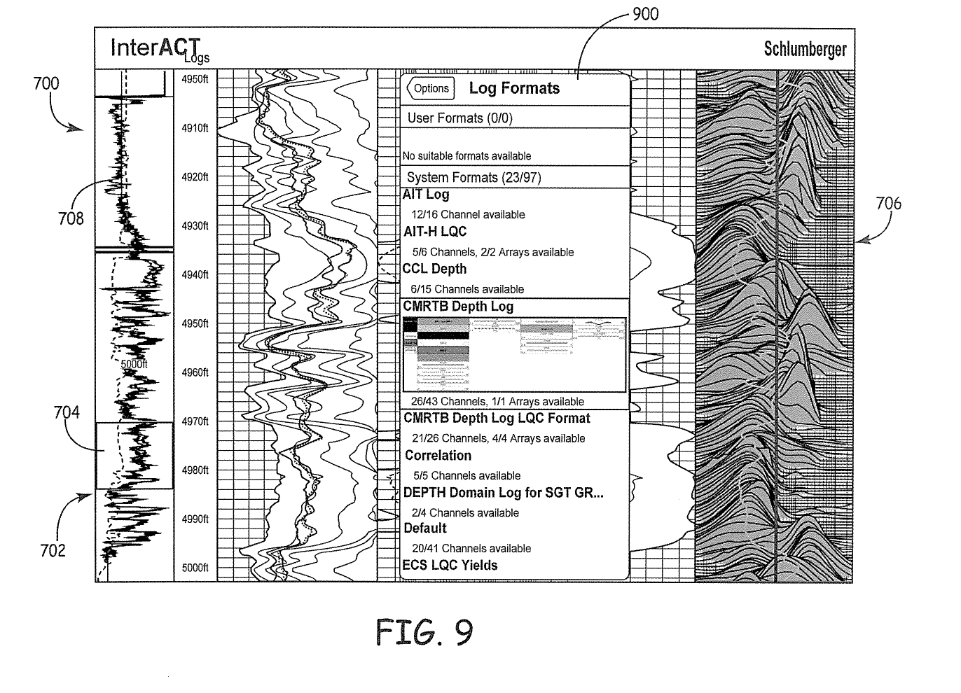

FIG. 9 is a screen shot of the mobile device application showing an interactive user interface 900 for selecting a well data log format for display on the mobile device. In the background of interactive user interface 900 are depth selection bar 702, displayed depth indicator 704, and data display section 706, and data preview bar 708, similar to the features illustrated in FIG. 7. In some embodiments, the user can access interactive user interface 900 by tapping or pressing the touch screen (e.g., a single tap). Interactive user interface 900 presents a list of log formats available for display on data display section 706. In some embodiments, the list of log formats is presented on interactive user interface 900 in order of relevance based on the well data being processed. For example, the mobile application can be configured to compare data associated with each log format definition with data that is available in the underlying dataset and list the log formats starting with the log formats best suited for the underlying data set. Interactive user interface 900 can be dynamic in that the list automatically updates based on changes in the data set.

When a user selects one of the log formats on interactive user interface 900, the mobile application generates a graphical display of the data in the selected log format for presentation in data display section 706. In some embodiments, the mobile application is configured such that the user can access other active log views by providing a swiping input on the touch screen display. In response to the swiping input, the mobile application then shifts the view displayed in data display section 706 to a different log format.

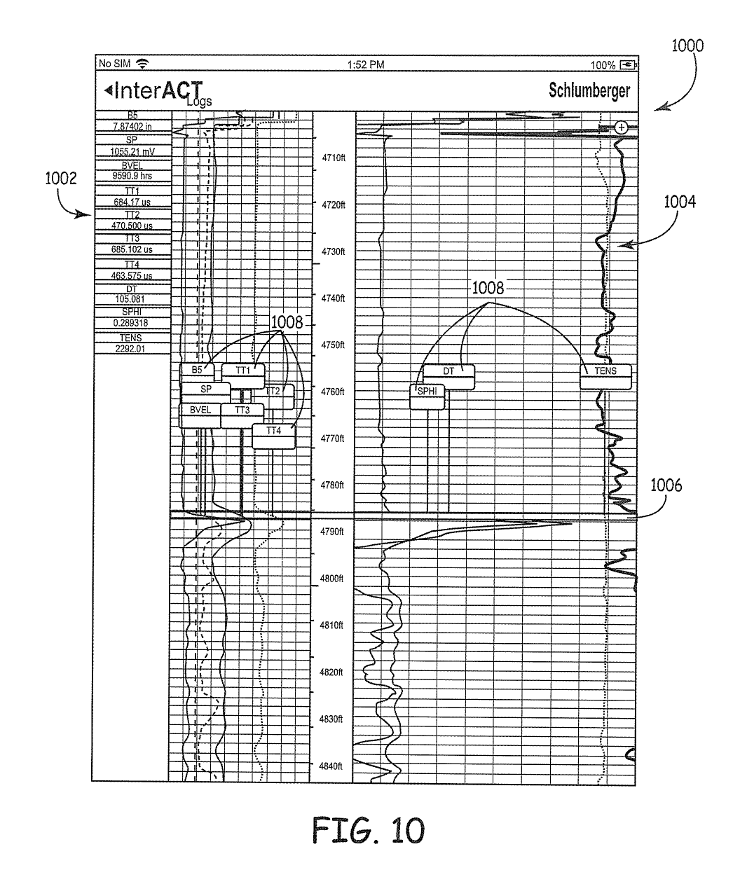

FIG. 10 is a screen shot of the mobile device application including interactive user interface 1000 employable to determine parameter values at a selected depth. Interactive user interface 1000 includes parameter value bar 1002 and data display area 1004. In the embodiment shown, data display area 1004 is displaying data in a sonic log format as described above. When a user presses and holds the touch screen on interactive user interface 1000, horizontal marker 1006 appears extending across the data display area, and pop-up indicators 1008 extend from horizontal marker 1006. Pop-up indicators 1008 define the data value of each of the data plots at horizontal marker 1006. The value associated with each pop-up indicator 1008 also appears in parameter value bar 1002. Horizontal marker 1006 may be shifted relative to the data display area by pressing and holding the horizontal marker 1006 and dragging or swiping the horizontal marker 1006 up or down (as viewed in FIG. 10). As horizontal marker 1006 is moved, the values in pop-up indicators 1008 and parameter value bar 1002 are updated with the data value at the new position of horizontal marker 1006. Pop-up indicators 1008 allow the user to quickly and accurately determine the value of any of the data plots at any depth.

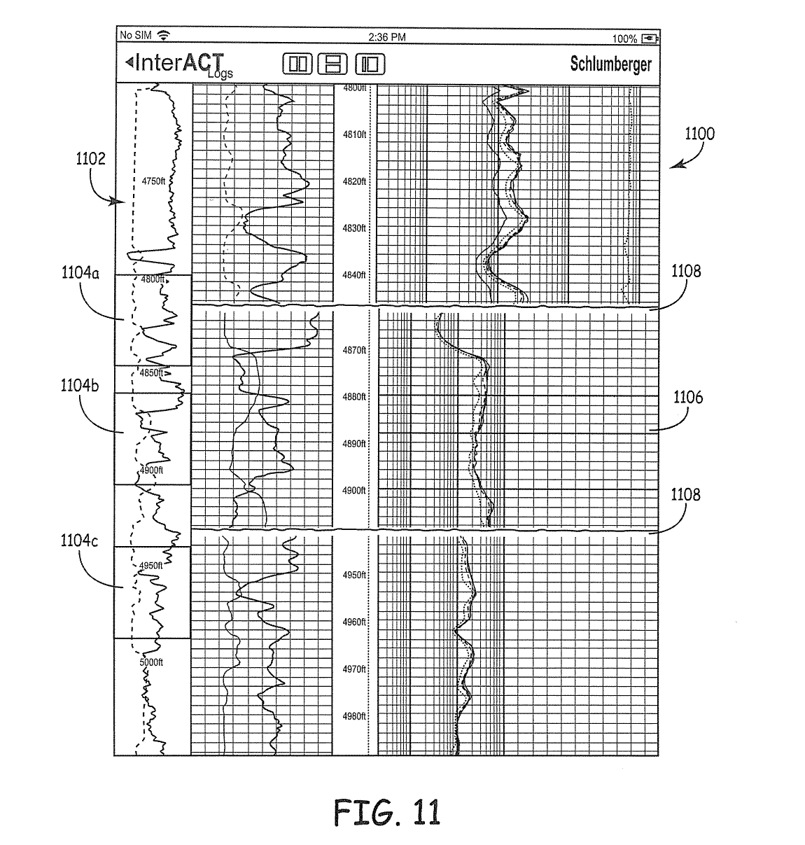

FIG. 11 is a screen shot of the mobile device application including an interactive user interface 1100 for graphically displaying well data at a plurality of discontinuous depths simultaneously. Interactive user interface 1100 includes depth selection bar 1102, similar to depth selection bar 702 shown above in FIG. 7. In this embodiment, a plurality of displayed depth indicators 1104a, 1104b, 1104c are displayed in depth selection bar 1102, each displayed depth indicator 1104a, 1104b, 1104c showing a range of well depths (relative to the surface) displayed in data display section 1106. The number of displayed depth indicators 1104 may be static, or may be changed by tapping or providing another type of input on depth selection bar 1102. Each displayed depth indicator 1104a, 1104b, 1104c is movable with respect to depth selection bar 1102, e.g., by pressing, holding, and dragging the displayed depth indicator 1104 to be moved. The range of depths associated with each displayed depth indicator 1104a, 1104b, 1104c may also be altered by providing a pinching or splaying input on displayed depth indicator 1104a, 1104b, 1104c to be changed, or by pressing, holding, and dragging the upper or lower limit of displayed depth indicator 1104a, 1104b, 1104c to be changed. Alternatively, an interactive user interface such as interactive user interface 800 described above may be presented when the displayed depth indicator 1104a, 1104b, 1104c to be changed is tapped or otherwise selected.

Data display section 1106 displays the data at the depths as selected by displayed depth indicators 1104a, 1104b, 1104c. As is shown, data display section 1106 is configured to display data at multiple discontinuous depths simultaneously. Adjacent discontinuous depth ranges may be separated on data display section 1106 by line 1108 or other demarcating element. For example, in some embodiments, lines 1108 are graphically represented as a tear line in paper to simulate the appearance of a plurality of torn paper log segments placed adjacent each other.

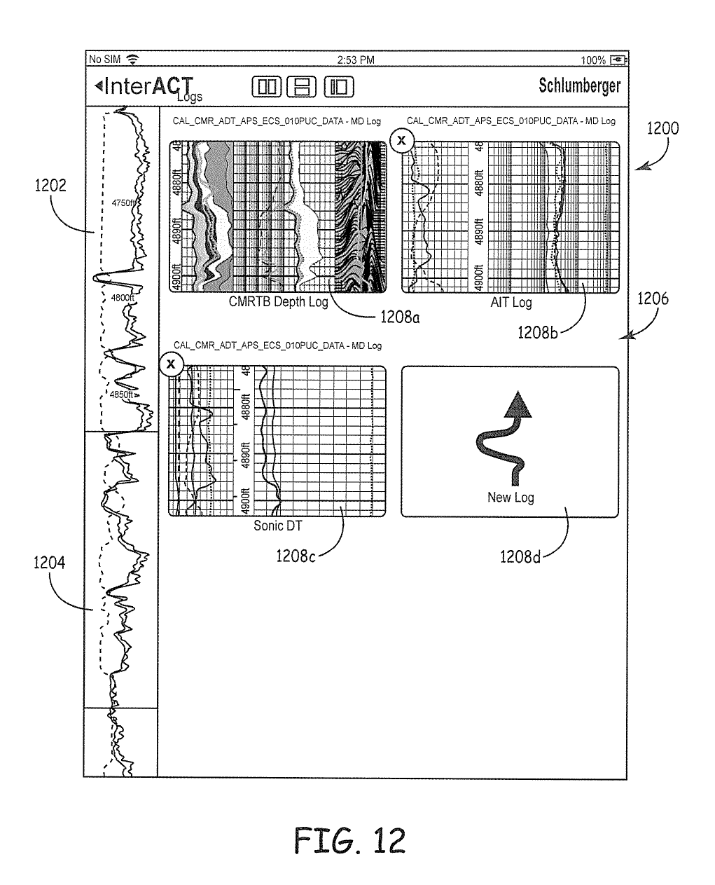

FIG. 12 is a screen shot of the mobile device application including an interactive user interface 1200 for providing a plurality of selectable well data log viewers. Interactive user interface 1200 includes depth selection bar 1202 and displayed depth indictor 1204, similar to depth selection bar 702 and displayed depth indicator 704, respectively, discussed above in FIG. 7. Interactive user interface 1200 also includes log viewer browser 1206, which allows the user to view a tiled arrangement of available active log viewer previews 1208a, 1208b, 1208c for selection. Active log viewer previews 1208a-1208c each include a thumbnail image of the data displayed upon selection of the associated Active log viewer previews 1208a-1208c. As discussed above, the mobile device application of the present disclosure can be configured to provide accessibility to multiple different data log formats (e.g., by swiping between the different formats). With interactive user interface 1200, the user can view available log viewers simultaneously to determine which active viewer to select, or whether to generate a new log viewer (by selecting new log viewer generator 1208d). The user can also close or deactivate any of the active log viewer previews 1208a-1208c via interactive user interface 1200 by pressing the “X” located at the upper corner of active log viewer previews 1208a-1208c.

Displayed depth indicator 1204 may be adjusted on depth selection bar 1202 as discussed above. In response to the modifying the range of depths covered by displayed depth indicator 1204, interactive user interface 1200 may be configured to update the thumbnail image associated with each of the active log viewer previews 1208a-1208c to reflect the data at the updated depth range.

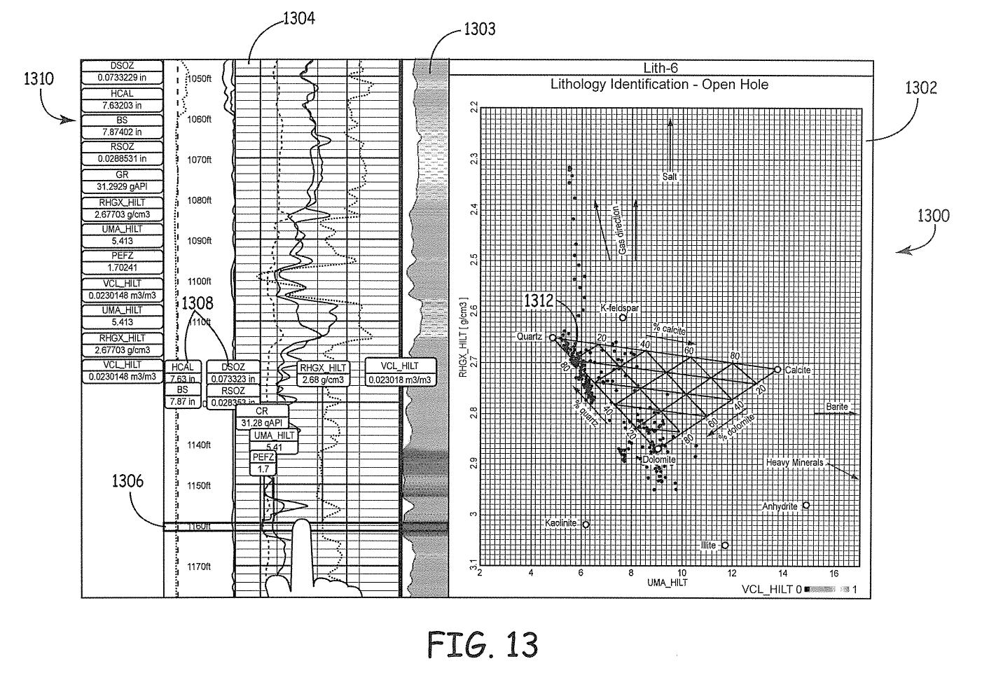

FIG. 13 is a screen shot of the mobile device application including interactive user interface 1300 for displaying a log interpretation chart 1302 in conjunction with well data in data display section 1304. Log interpretation charts are used to perform an interpretation on depth or time based data. Interactive user interface 1300 is configured to plot data in real-time or substantial real-time on a background plot specific to a particular type of interpretation. For example, log interpretation chart 1302 relates to lithology identification in an open hole well, which involves identifying mineralogy of the formation in the area of the well through a comparison of apparent matrix grain density of the formation and an apparent matrix volumetric photoelectric factor of the formation. In the illustrated embodiment, interactive user interface 1300 also represents the interpreted lithology in lithology chart 1303. Other log interpretation chart backgrounds are also possible. In some embodiments, the mobile device application lists log interpretation chart backgrounds that can be plotted based on the underlying well data.

Interactive user interface 1300 allows the user to select the data range displayed in data display section 1304. In some embodiments, interactive user interface 1300 includes a depth selection bar and displayed depth indicator, similar to depth selection bar 702 and display depth indicator 704 discussed above with regard to FIG. 7. Interactive user interface 1300 may also be configured to provide access to a graphical depth range selection module, such as interactive user interface 800 described above with regard to FIG. 8. The ability to set the depth range allows the user to localize the data interpreted to a desired section of the formation. The user can also provide a swiping input up or down on data display section 1304 (relative to the screen shot in FIG. 13) to shift the displayed data range. A pinch or splay input on data display section 1304 can be applied to increase or decrease the displayed data range. When the user updates the displayed data range, the data on log interpretation chart 1302 is correspondingly updated to reflect the data in the updated data range.

Interactive user interface 1300 is also configured to allow the user to press and hold on data display section 1304 to generate horizontal marker 1306 at a particular depth, similar to horizontal marker 1006 discussed above with regard to FIG. 10. Pop-up indicators 1308 extend from horizontal marker 1306 and define the data value of each of the data plots at horizontal marker 1306. The value associated with each pop-up indicator 1008 also appears in parameter value bar 1308. In addition, interpreted data (e.g., lithology identification) at the depth at horizontal marker 1306 is highlighted in log interpretation chart 1302 at data plot 1312. Horizontal marker 1306 may be shifted relative to the data display area by pressing and holding the horizontal marker 1306 and dragging or swiping the horizontal marker 1306 up or down (as viewed in FIG. 13). As horizontal marker 1306 is moved, the values in log interpretation chart 1302, pop-up indicators 1308, parameter value bar 1310 are updated with data values at the new position of horizontal marker 1306.

FIG. 14 is a plan view of a plurality of mobile devices 1400a, 1400b, 1400c, 1400d, 1400e, and 1400f (e.g., tablet, cellular telephone, etc.) using the mobile device application and collaborating to display multiple logs of well data at a plurality of depths. While six mobile devices 1400a-1400f are shown in FIG. 14, it will be appreciated that any number of mobile devices can be configured to collaborate. Mobile devices 1400a-1400f communicate with each other via integrated communication interfaces. For example, mobile devices 1400a-1400f may be networked directly with each other, or may communicate over a central wireless hub or router. Mobile devices 1400a-1400f can also collaborate when located remotely from each other to analyze a data set simultaneously from remote locations.

When collaborating, the mobile application on each of mobile devices 1400a-1400f can synchronize the depth and time data displayed on each of the touch screens so that multiple log formats and/or data at varying depths can be displayed across mobile devices 1400a-1400f simultaneously. To assist with the display and interpretation of the data by users, mobile devices 1400a-1400f can be positioned adjacent to each other to provide the look of a continuous paper log across the mobile devices. In the illustrated embodiment, mobile devices 1400a-1400d are arranged side-by-side to display different log formats at the same depth, and mobile devices 1400a, 1400e, and 1400f are arranged in a top-to-bottom arrangement to display the same log format at different depths.

In a collaborating arrangement, mobile devices 1400a-1400f can be configured such that user input on one of mobile devices 1400a-1400f affects the displayed data on each of the other mobile devices 1400a-1400f. For example, in the collaborating arrangement of FIG. 14, if an up or down swiping input is provided on mobile device 1400a, the displayed depths on all mobile devices 1400a-1400f shift in the direction of the swiping input. As another example, if a left or right swiping input is provided on one of mobile devices 1400a-1400f, the displayed logs may shift on all mobile devices 1400a-1400f in the direction of the swiping input. More particularly, in the collaborating arrangement of FIG. 14, if a left swiping input is provided on mobile device 1400a, the log format on mobile device 1400b shifts to mobile devices 1400a, 1400e, and 1400f, the log format on mobile device 1400c shifts to mobile device 1400b, and so on. If additional log formats are active, a previously undisplayed log format may appear on mobile device 1400d in response to the left swiping input on mobile device 1400a.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A mobile device for providing visualization and manipulation of well data generated from one or more well sites, the well data collected, stored, and aggregated on one or more aggregated data servers, the mobile device comprising:
a touch screen display;
a communication interface; and
a processor operatively connected to the touch screen display and the communication interface, the processor configured to receive well data from the one or more aggregated data servers via the communication interface and display a user interface on the touch screen display that graphically displays elements of the well data, wherein the processor is further configured to receive user inputs from the touch screen display and update the displayed well data on the graphical display based the user inputs received on the touch screen display.

2. The mobile device of claim 1, wherein the processor is configured to receive a swiping input on the touch screen display and shift the graphically displayed elements of the well data in a direction of the swiping input.

3. The mobile device of claim 2, wherein the processor is configured to provide access to a plurality of log formats on the touch screen display, each log format based on a data subset from the well data, wherein the processor is configured to change a log format displayed on the touch screen display in response to the swiping input.

4. The mobile device of claim 1, wherein the processor is configured to receive a press-and-hold input at a position on the touch screen display, and wherein the processor is further configured to display one or more parameter values on the user interface at the position of the press-and-hold input.

5. The mobile device of claim 1, wherein the processor is configured to receive a pinch input or splay input on the touch screen display, and wherein the processor is further configured to zoom out on the graphically displayed well data elements in response to a pinch input and to zoom in on the graphically displayed well data elements in response to a splay input.

6. The mobile device of claim 1, wherein the processor is configured to provide access to a plurality of selectable log format display options on the user interface, each log format display option associated with a displayable log format based on a data subset from the well data, wherein the log format display options are provided in order of relevance of the associated log format to the well data.

7. The mobile device of claim 6, wherein the processor is configured to generate a log view when one of the log format display options is selected on the touch screen display, and wherein the processor is further configured to display a selectable log view preview of each of the log views and display the log view associated with the log view preview selected on the touch screen display.

8. The mobile device of claim 1, wherein the processor is configured to provide access to an email delivery option on the user interface to facilitate email delivery of the graphically displayed well data and to facilitate access to the well data.

9. The mobile device of claim 1, wherein the processor is configured to provide a data range selection screen on the user interface that facilitates selection of a range of a well data parameter for graphical display on the touch screen display.

10. The mobile device of claim 9, wherein the processor is configured to display a preview thumbnail on the data range selection screen, and wherein the preview thumbnail provides a preview of the graphically displayed elements of the well data in the selected range of the well data parameter.

11. The mobile device of claim 9, wherein the well data parameter is well depth.

12. The mobile device of claim 11, wherein the processor is configured to facilitate display of a plurality of discontinuous well depth ranges simultaneously on the touch screen display.

13. The mobile device of claim 1, wherein the processor is configured to communicate with one or more other mobile devices via the communication interface.

14. The mobile device of claim 13, wherein the processor is configured to collaborate with the one or more other mobile devices to graphically display the elements of the well data across a plurality of mobile devices.

15. The mobile device of claim 14, wherein the processor is configured to communicate with the one or more other mobile devices to display a different parameter range of the well data on each of the mobile devices.

16. The mobile device of claim 15, wherein the processor is configured update the well data parameter ranges displayed on the collaborating one or more other mobile devices in response to user inputs on the touch screen display.

17. The mobile device of claim 1, wherein the processor is configured to generate a log interpretation chart based on the well data in response to selection of a log interpretation chart generation option on the user interface.

18. The mobile device of claim 17, wherein the processor is configured to graphically display the log interpretation chart on the touch screen display in conjunction with the well data elements, and wherein the processor is further configured to adjust the information displayed on the log interpretation chart in response to user inputs on the user interface.
